(19) United States
(12) Patent Application Publication
(10) Pub. No.: US 2017/0059138 A1
(43) Pub. Date: Mar. 2, 2017

(54) SNAP-ON SHADE NUT

(71) Applicant: Evolution Lighting, LLC, Miami Lakes, FL (US)

(72) Inventor: Jose Bernal, Miami, FL (US)

(73) Assignee: Evolution Lighting, LLC, Miami Lakes, FL (US)

(21) Appl. No.: 14/840,796

(22) Filed: Aug. 31, 2015

(51) Int. Cl. F21V 17/16

(52) U.S. Cl. CPC F21V 17/164

(57) ABSTRACT

A snap-on shade nut for securing a portion of a lamp shade to a lamp holder assembly includes a ring-shaped portion and at least one clip. The ring-shaped nut has an aperture sized to receive a threaded lamp holder, and a threaded portion on an inner surface within the aperture such that the threaded portion extends through the aperture. The clip or clips extend outward from a periphery of the ring-shaped nut in a direction perpendicular to an axis of the threaded portion so that a base portion of a lamp shade can be snapped onto the clip and be retained by the clip. The snap-on shade nut may be pre-attached to a lamp holder at manufacturing time or other time prior to sale to the consumer.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of lighting, and in particular to a novel shade nut for securing a lamp shade.

### BACKGROUND

FIG. 1 shows a typical top front 110 of a lamp base having a threaded lamp holder 120. To secure a lampshade 130 to the lamp base, a conventional shade nut 140 is threaded onto the lamp holder 120. Use of the conventional shade nut 140 requires the consumer to place the shade onto the lamp holder assembly of a portable lamp and secure it with the shade nut 140 while simultaneously holding three items—the lamp shade, the lamp base and the shade nut 140. This creates a substantial assembly difficulty.

As shown in FIG. 2, on up-facing-shade portable lamps with heights greater than five feet, the assembly difficulty is compounded by the need to assemble the shade to the lamp base while holding the three items at a tilted angle. At such time, there is substantial risk of the lamp shade becoming dislodged. Where the shade 130 is a glass bowl, breakage due to dislodgement of the lamp shade during assembly is common.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a side view illustrating a lamp holder, shade and shade nut according to the prior art.

FIG. 2 is a side view illustrating a lamp holder, shade and shade nut, at an angle, according to the prior art.

FIG. 3a shows a side view illustrating a snap-on shade nut according to an embodiment of the present invention.

FIG. 3b shows a top view illustrating a snap-on shade nut according to an embodiment of the present invention.

FIG. 4 shows side view illustrating an embodiment of the snap-on shade nut affixed to a threaded lamp holder of a lamp, with a shade member detached.

FIG. 5 shows side view illustrating an embodiment of the snap-on shade nut affixed to a threaded lamp holder of a lamp, with a shade member snapped on to the snap-on shade nut.

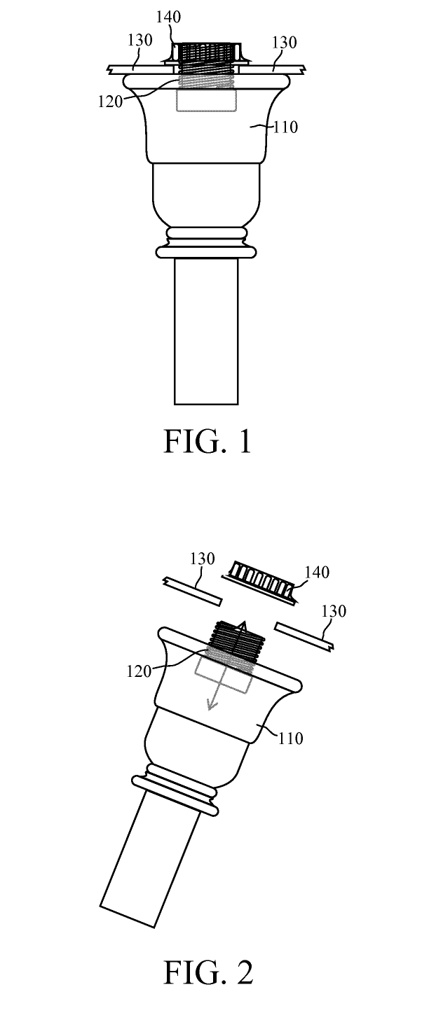

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

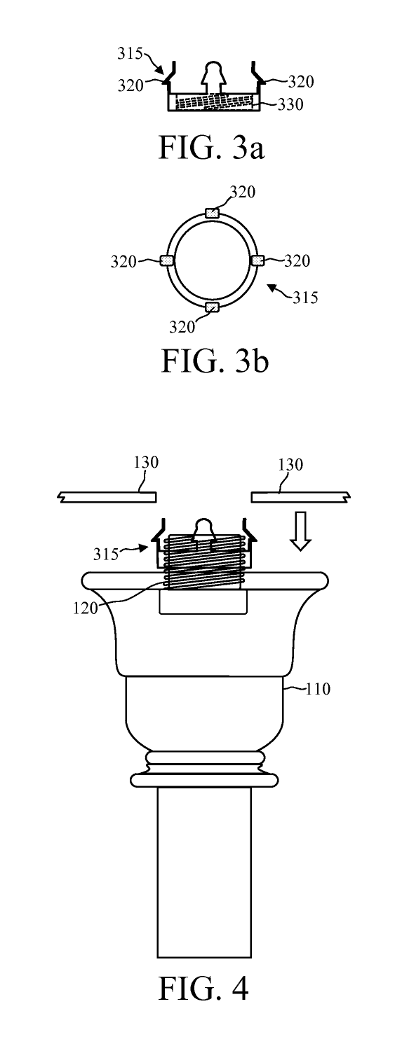

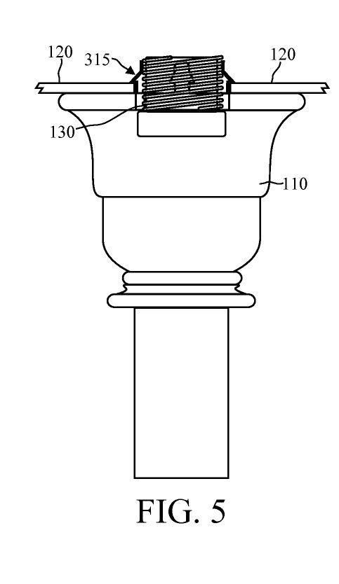

FIGS. 3a and 3b shows a side view and a top view, respectively, illustrating a snap-on shade nut 315 according to an embodiment of the present invention. The snap-on shade nut 315 is ring shaped, and in an embodiment is generally round with an aperture for receiving a threaded lamp holder. In various embodiments, the snap-on shade nut can be octagonal, square, or otherwise include ridges on its outer surface which provide improved grip for threading the nut onto a threaded lamp holder with fingers or a tool such as a wrench.

The ring-shaped snap-on shade nut 315 has a threaded portion 330 which allows the nut to be threaded onto the threaded lamp holder 120. The ring-shaped snap-on shade nut 315 further has clips 320 that are, in an embodiment, semi-flexible and extend in a direction perpendicular to the axis of the threaded portion 330. The semi-flexible clips 320 allow the consumer to snap a shade member 130 of the shade onto the shade nut to secure the shade onto the lamp holder assembly. The snap-on shade nut 315 may optionally be pre-attached to the lamp holder at the factory, or at another time prior to sale to the consumer, so as to allow the consumer to snap the shade onto the nut and tighten the nut onto the lamp holder assembly with reduced risk of the shade being dropped and damaged. The snap-on shade nut 315 may employ as many clips 320 of varying designs as required to retain the shade while securing the nut. The clips 320 can comprise a flexible material such as metal or plastic, so that they can act as spring clips. In such embodiments, the clips 320 bend in when shade member 130 is pressed down onto the shade nut until the shade 130 snaps into place. The shade member 130 snaps onto the clips 320, which prevent it from falling while tightening shade the shade nut. The clips 320 form tabs that can then be used to tighten the nut onto the threaded lamp holder 120 so as to secure the shade member 130 further onto the assembly without the risk of the shade member 130 detaching from the assembly. The shade member 130 may be, e.g., a glass bowl or other base of a lamp shade.

The snap-on shade nut 315 and the clips 320 may be composed of metal, and the nut portion may be fabricated separately from the clips 320 or fabricated together with them so as to provide unitary piece.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A snap-on shade nut, comprising:
a ring-shaped nut having an aperture therethrough that is sized to receive a threaded lamp holder, the ring-shaped nut further comprising;
a threaded portion on an inner surface within the aperture, the threaded portion extending at least partially through the aperture; and,
at least one clip extending outward from a periphery of the ring-shaped nut in a direction perpendicular to an axis of the threaded portion, whereby a base portion of a lamp shade can be snapped onto the clip and be retained by the clip.

2. The snap-on shade nut according to claim 1, wherein the at least one clip comprises a plurality of clips around a periphery of the ring-shaped nut.

3. The snap-on shade nut according to claim 2, wherein the plurality of clips form tabs extending upwardly from a top surface of the ring-shaped nut in a direction parallel to the axis of the threaded portion.

4. The snap-on shade nut according to claim 1, wherein the at least one clip is semi-flexible so as to form a spring clip.

5. The snap-on shade nut according to claim 1, wherein the base portion of the lamp shade comprises an attachment portion of the lamp shade.

6. The snap-on shade nut according to claim 1, wherein the at least one clip comprises four spring clips extending in a direction perpendicular to the axis of the threaded portion.

7. A method, comprising:
forming a ring-shaped nut having an aperture therethrough that is sized to receive a threaded lamp holder;
forming a threaded portion on an inner surface within the aperture, the threaded portion being formed on a plane extending through the aperture; and,
forming at least one clip extending in a direction perpendicular to the plane of the threaded portion.

8. The method of claim 7, further comprising a step of pre-attaching the snap-on shade nut to a lamp holder.

9. The method of claim 8, wherein the step of pre-attaching the snap-on shade nut to a lamp holder is performed at manufacturing time.

10. The method of claim 8, wherein said step of pre-attaching the snap-on shade nut to a lamp holder is performed prior to a sale to a consumer.

11. The method of claim 8, wherein the step of pre-attaching the snap-on shade nut to a lamp holder comprises pre-attaching the snap-on shade nut to a lamp holder of a lamp that is greater than five feet in height.

12. The method of claim 7, wherein the step of forming the ring-shaped nut and the step of forming the at least one clip are performed simultaneously.

13. The method of claim 7, wherein the step of forming at least one clip comprises forming a plurality of clips around a periphery of the ring-shaped nut.

14. The method of claim 13, wherein the step of forming the plurality of clips comprises forming tabs extending upwardly from a top surface of the ring-shaped nut in a direction parallel to the axis of the threaded portion.

15. The method of claim 7, wherein the step of forming at least one clip comprises at least one spring clip.

16. The method of claim 15, wherein the step of forming at least one spring clip comprises forming at least one spring clip from semi-flexible material.

17. The method of claim 16, wherein the step of forming at least one spring clip comprises forming a metal spring clip.

18. The method of claim 15, wherein the step of forming at least one spring clip comprises forming four spring clips extending in a direction perpendicular to the axis of the threaded portion.

19. The method of claim 7, further comprising a step of tightening the ring-shaped nut onto the lamp holder.

20. The method of claim 7, further comprising a step of snapping an attachment portion of a lamp shade onto the clip such that the base portion of the lamp shade is retained by the clip.
